(19) United States
(12) Patent Application Publication
(10) Pub. No.: US 2012/0300994 A1
(43) Pub. Date: Nov. 29, 2012

(54) Method and System for Managing Working Hours Using Post-Factum Fingerprint Registration

(75) Inventor: Yong Soo Kim, Gamgnam-gu (KR)

(73) Assignee: DIGITAL INTERACTIVE CO., Seoul (KR)

(21) Appl. No.: 13/575,639

(22) PCT Filed: Jan. 24, 2011
(86) PCT No.: PCT/KR2011/000467

§ 371 Date: Jul. 27, 2012

(30) Foreign Application Priority Data
Jan. 27, 2010 (KR) 10-2010-0007352

(51) Int. Cl. G06K 9/00

(52) U.S. Cl. 382/124

(57) ABSTRACT

A method for managing working hours using post-factum fingerprint registration according to one embodiment of the present invention comprises the steps of: acquiring the working hours of a user in response to an ID inputted from the user and each of a plurality of fingerprint images corresponding to the ID; storing the ID, the fingerprint images, and the working hours; selecting the post-factum registration fingerprint image for ID from the fingerprint images; and comparing the post-factum registration fingerprint image with the remaining fingerprint images.

### TECHNICAL FIELD

Exemplary embodiments relate to a method and system for managing working hours.

### BACKGROUND

Recently, a system for managing working hours using fingerprint recognition is being widely used.

However, a general system for managing working hours using fingerprint recognition requires pre-registration of fingerprints of employees through an operator. This may cause an inconvenience not only to the operator but also the employees.

The general system for managing working hours using fingerprint recognition needs to scan a fingerprint of an employee inputted each time the employee clocks in, and verify whether the real-time inputted fingerprint matches the pre-registered fingerprint. In this instance, when the fingerprint of the employee is faint and a scanner is dirty to some extent, even though the employee places a finger on the scanner in a proper manner, the system for managing working hours may recognize the fingerprint as a non-matched fingerprint and may request the employee to place the finger on the scanner again. In this case, the employee needs to place the finger on the scanner until the system for managing working hours recognizes the fingerprint properly. This may be the source of a nuisance to the employees at peak hours.

For example, when the system for managing working hours recognizes, as a non-matched fingerprint, a fingerprint submitted by an employee X who arrives at work at eight fifty-five in the morning, in advance of a clock-in time limit, that is, nine o'clock in the morning, attendance of the employee X may be processed as a tardy arrival although such processing is unintended by the system. Furthermore, attendance of employees Y and Z awaiting subsequent turns behind the employee X may be also processed as tardy arrivals.

Also, when the quality of the fingerprint is too poor to recognize, it may be impossible to record the working hours or working time using the fingerprint.

### SUMMARY

An aspect of the present invention provides a method and system for managing working hours that may improve working efficiency of a user, by comparing fingerprints inputted after recording the working hours of the user, but not by comparing a real-time inputted fingerprint to a pre-registered fingerprint.

Another aspect of the present invention provides a method and system for managing working hours that may solve an inconvenience of a user caused by an error in fingerprint recognition, by comparing fingerprints inputted after recording the working hours of the user.

Still another aspect of the present invention provides a method and system for managing working hours using post-factum fingerprint registration that may record the working hours before an employee is assigned a user identification (ID) or when the employee forgets the user ID.

Further another aspect of the present invention provides a method and system for managing working hours using post-factum fingerprint registration that may even be applied to a user having a fingerprint impossible to be recognized, thereby saving an amount of time taken to re-input a fingerprint caused by a failure in fingerprint recognition.

According to an aspect of the present invention, there is provided a method for managing working hours using post-factum fingerprint registration, the method including determining working hours of a user in response to provision of an identification (ID) inputted from the user and each of a plurality of fingerprint images corresponding to the ID, storing the ID, the plurality of fingerprint images, and the working hours, selecting a post-factum registration fingerprint image for the ID from the plurality of fingerprint images, and comparing the post-factum registration fingerprint image to the remaining fingerprint images among the plurality of fingerprint images.

In this instance, the determining of the working hours of the user may include determining the working hours of the user irrespective of whether the plurality of fingerprint images are fingerprint images of the user.

In this instance, the storing of the ID, the plurality of fingerprint images, and the working hours may include storing the ID, the plurality of fingerprint images, and the working hours with the ID mapped to the plurality of fingerprint images.

In this instance, the ID may include at least one temporary ID assigned to the user for a short period of time, and the method may further include mapping the at least one temporary ID to the ID corresponding to the plurality of fingerprint images.

In this instance, the storing of the ID, the plurality of fingerprint images, and the working hours may include extracting feature data from the plurality of fingerprint images, and performing lossy compression on the plurality of fingerprint images and storing the plurality of lossy compressed fingerprint images.

In this instance, the selecting of the post-factum registration fingerprint image may include selecting, as the post-factum registration fingerprint image, a first stored fingerprint image or a last stored fingerprint image among the plurality of fingerprint images, when the post-factum registration fingerprint image is absent.

The comparing of the post-factum registration fingerprint image to the remaining fingerprint images among the plurality of fingerprint images may include comparing a match rate of the post-factum registration fingerprint image and the plurality of fingerprint images, and recording a warning with respect to the ID corresponding to the plurality of fingerprint images when the match rate is lower than a predetermined match rate.

Here, the selecting of the post-factum registration fingerprint image may include determining whether a number of times at which the match rate is lower than the predetermined match rate corresponds to a predetermined number of times, and selecting, as the post-factum registration fingerprint image, one of the plurality of fingerprint images aside from the post-factum registration fingerprint image, when it is determined that the number of times at which the match rate is lower than the predetermined match rate corresponds to the predetermined number of times.

According to another aspect of the present invention, there is provided a system for managing working hours using post-factum fingerprint registration, the system including a working hours managing unit to determine working hours of a user in response to provision of an ID inputted from the user and each of a plurality of fingerprint images corresponding to the ID, a storage unit to store the ID, the plurality of fingerprint images, and the working hours, a selecting unit to select a post-factum registration fingerprint image for the ID from the plurality of fingerprint images, and a comparing unit to compare the post-factum registration fingerprint image to the remaining fingerprint images among the plurality of fingerprint images.

In this instance, the system may further include an output unit to output a result of the comparison.

Here, the output unit may generate an alarm for at least one of the plurality of fingerprint images based on the result of the comparison.

In this instance, the working hours managing unit may determine the working hours of the user irrespective of whether the plurality of fingerprint images are fingerprint images of the user.

The storage unit may store the ID, the plurality of fingerprint images, and the working hours, with the ID mapped to the plurality of fingerprint images.

The storage unit may extract feature data from the plurality of fingerprint images and may store partial images of the plurality of fingerprint images. In this example, the ID may include at least one temporary ID assigned to the user for a short period of time.

Here, the system may further include a mapping unit to map the at least one temporary ID to the ID corresponding to the plurality of fingerprint images.

In this instance, the storage unit may compress the plurality of fingerprint images by a lossless image compression algorithm, and may store the plurality of compressed fingerprint images.

The storage unit may extract feature data from the plurality of fingerprint images, may perform lossy compression on the plurality of fingerprint images, and may store the plurality of compressed fingerprint images.

The selecting unit may select the post-factum registration fingerprint image at random.

Further, the selecting unit may select, as the post-factum registration fingerprint image, a first stored fingerprint image or a last stored fingerprint image among the plurality of fingerprint images when the post-factum registration fingerprint image is absent.

The comparing unit may record a warning with respect to the ID corresponding to the plurality of fingerprint images when a match rate of the post-factum registration fingerprint image and the plurality of fingerprint images is lower than a predetermined match rate based on the result of the comparison.

Here, the selecting unit may select, as the post-factum registration fingerprint image, one of the plurality of fingerprint images aside from the post-factum registration fingerprint image when it is determined that a number of times at which the match rate is lower than the predetermined match rate corresponds to a predetermined number of times.

According to an exemplary embodiment of the present invention, an operator and an employee may have a reduced labor burden by eliminating a procedure for pre-registering a fingerprint of the employee before recording the working hours of the employee.

Also, according to an exemplary embodiment of the present invention, an employee may record the working hours before the employee is assigned a user identification (ID) or even though the employee forgets the user ID.

Also, according to an exemplary embodiment of the present invention, even an employee having a fingerprint not too good to recognize may record the working hours without wasting time.

### BRIEF DESCRIPTION OF DRAWINGS

FIG. 1 is a diagram illustrating concept of a method and system for managing working hours using post-factum fingerprint registration according to an exemplary embodiment of the present invention.

FIG. 2 is a flowchart illustrating a method of managing working hours using post-factum fingerprint registration according to an exemplary embodiment of the present invention.

FIG. 3 is a diagram illustrating a fingerprint recognition terminal liked to a system for managing working hours using post-factum fingerprint registration according to an exemplary embodiment of the present invention.

FIG. 4 is a diagram illustrating identification (ID) mapping in a method and system for managing working hours using post-factum fingerprint registration according to an exemplary embodiment of the present invention.

FIG. 5 is a diagram illustrating a fingerprint match rate and a fingerprint image in a method and system for managing working hours using post-factum fingerprint registration according to an exemplary embodiment of the present invention.

FIG. 6 is a block diagram illustrating a system for managing working hours using post-factum fingerprint registration according to an exemplary embodiment of the present invention.

### DETAILED DESCRIPTION

Reference will now be made in detail to embodiments of the present invention, examples of which are illustrated in the accompanying drawings, wherein like reference numerals refer to the like elements throughout. The embodiments are described below in order to explain the present invention by referring to the figures.

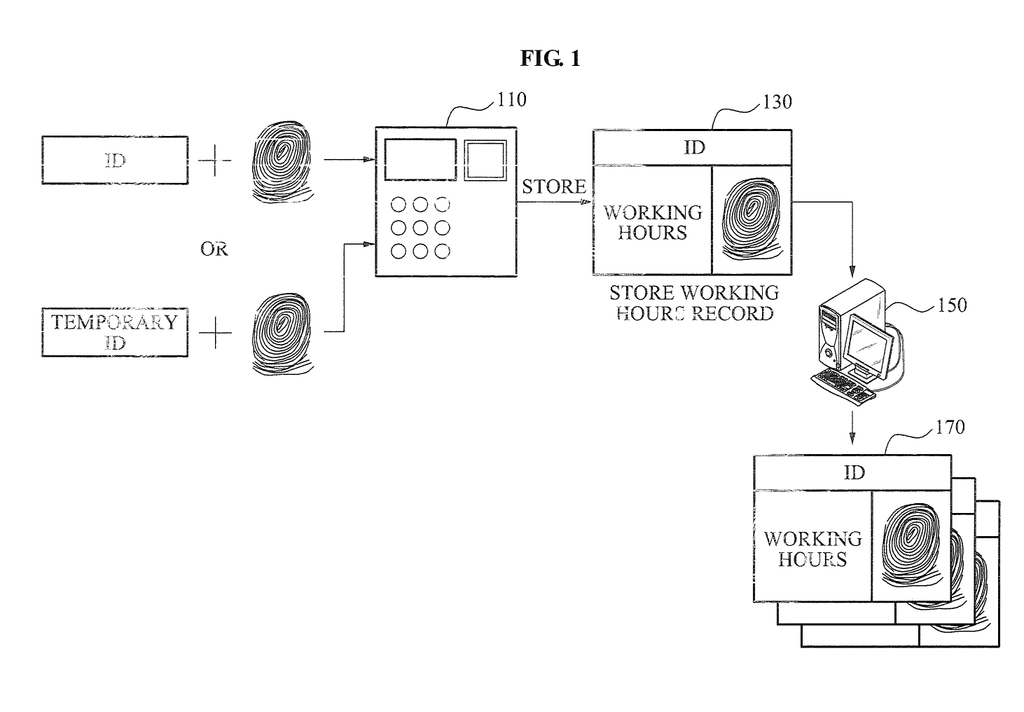

FIG. 1 is a diagram illustrating concept of a method and system for managing working hours using post-factum fingerprint registration according to an exemplary embodiment of the present invention.

Referring to FIG. 1, an employee may record the working hours by inputting an identification (ID) and a fingerprint in a fingerprint recognition terminal 110 without a pre-registration procedure. When the employee fails to recall the ID, a resident registration number or a telephone number may be used as a temporary ID. In this instance, the fingerprint recognition terminal 110 may store the inputted fingerprint as well as the ID, such as a user ID or a temporary ID, and the working hours.

The record 130 including the ID, the working hours, and the fingerprint stored in the fingerprint recognition terminal 110 may be transmitted to a system 150 for managing working hours, through various media, for example, a universal serial bus (USB) memory and transmission control protocol/internet protocol (TCP/IP), and may be accumulatively stored as a working hours record 170.

In this instance, since a procedure of comparing a real-time inputted fingerprint to a pre-registered fingerprint is eliminated, a waste of time caused by a failure in fingerprint recognition may be prevented.

Also, the system for managing working hours using post-factum fingerprint registration according to an exemplary embodiment of the present invention may determine when the user arrives at work and leaves work, and goes out and returns to work, and the like, by registering an arbitrary fingerprint image among the plurality of stored fingerprint images as a post-registered fingerprint image and by comparing the post-registered fingerprint image to the plurality of fingerprint images.

In this instance, a fingerprint inputted on a first work day or a last day of the month of the first work day, as a default value, may be set as the post-registered fingerprint image, and in this case, a process of selecting the arbitrary fingerprint image among the plurality of fingerprints to register the post-registered fingerprint image may be eliminated.

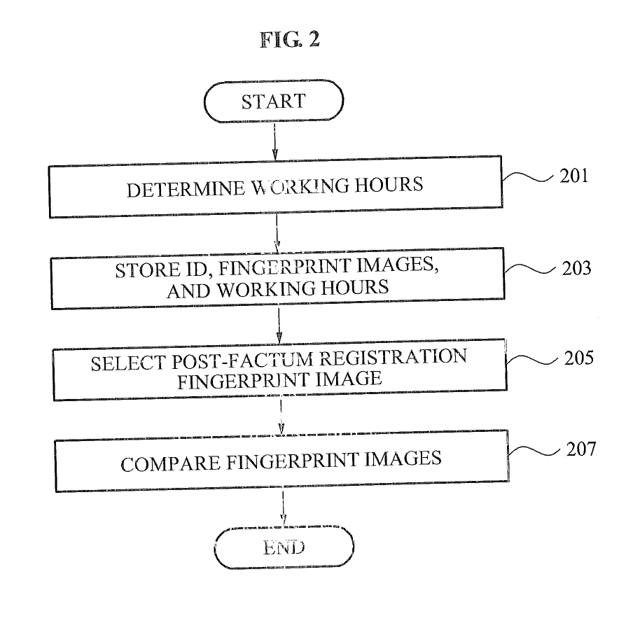

FIG. 2 is a flowchart illustrating a method of managing working hours using post-factum fingerprint registration according to an exemplary embodiment of the present invention.

Referring to FIG. 2, in operation 201, the method of managing working hours using post-factum fingerprint registration may determine the working hours of a user in response to provision of an ID inputted from the user and each of a plurality of fingerprint images corresponding to the ID.

That is, the method of managing working hours using post-factum fingerprint registration may determine the working hours of the user from any fingerprint image inputted by the user, irrespective of whether the plurality of fingerprint images are fingerprint images of the user. Accordingly, the method of managing working hours using post-factum fingerprint registration may prevent a situation in which recording of working hours is delayed due to a failure in fingerprint recognition or it is impossible to record the working hours, from occurring.

In this instance, the ID and the plurality of fingerprint images corresponding to the ID may be provided from the fingerprint recognition terminal linked to the system for managing working hours, through various media, for example, a universal serial bus (USB) memory and transmission control protocol/internet protocol (TCP/IP).

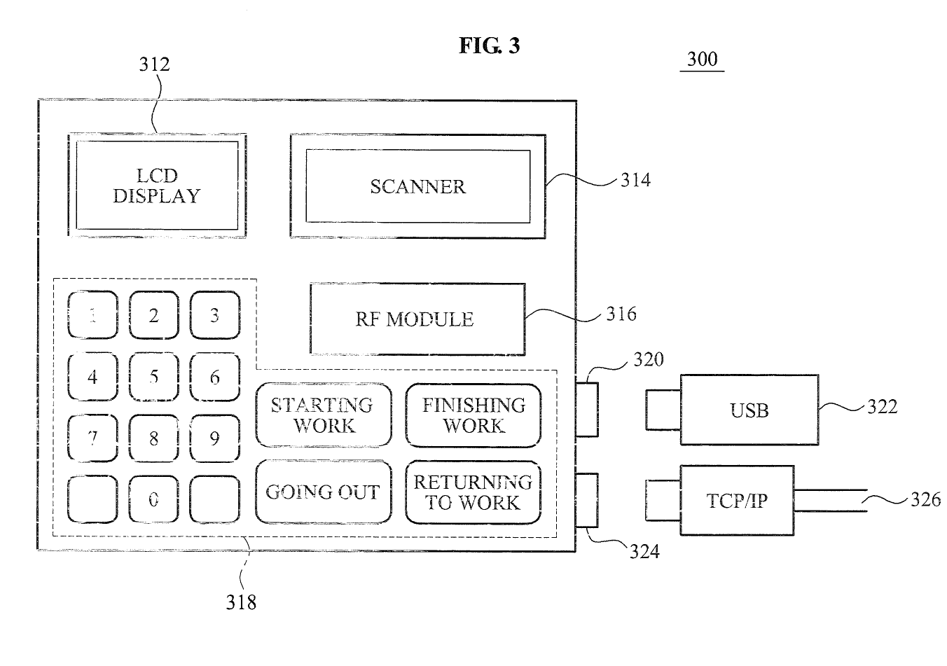

The fingerprint recognition terminal linked to the system for managing working hours using post-factum fingerprint registration according to an exemplary embodiment of the present invention is described with reference to FIG. 3.

FIG. 3 is a diagram illustrating the fingerprint recognition terminal 300 liked to the system for managing working hours using post-factum fingerprint registration according to an exemplary embodiment of the present invention.

Referring to FIG. 3, the fingerprint recognition terminal 300 may include a liquid crystal display (LCD) display 312, a scanner 314, a radio-frequency (RF) module 316, a keypad 318, a USB connecting terminal 320, and a communication terminal 324.

The LCD display 312 may display working hours, an inputted ID, and a fingerprint image.

The scanner 314 may receive an input of a fingerprint for recording working hours from a user.

The RF module 316 may process information inputted from an RF card when an input of an ID is replaced with the RF card.

The keypad 318 may be used for a user to input an ID and an event, for example, arriving at work, leaving work, going out, and returning to work.

The USB connecting terminal 320 may be used in transmitting and storing data through a USB memory 322.

The communication terminal 324 may enable data transmission via TCP/IP 326.

In operation 201 of determining the working hours of the user, the working hours of the user may be determined irrespective of whether the plurality of fingerprint images are fingerprints of the user.

Since the method of managing working hours using post-factum fingerprint registration does not require a comparison of an inputted fingerprint to a pre-registered fingerprint in real-time to record or determine the working hours of the user, even though a quality of the fingerprint of the user is relatively poor for recognition and the scanner is in a relatively poor condition, the user may avoid an unfavorable result caused by the foregoing situations. That is, the need for fingerprint re-input caused by a failure in fingerprint recognition may be eliminated so that the user may save a time taken to re-input a fingerprint.

In operation 203, the system for managing working hours using post-factum fingerprint registration may store the ID, the plurality of fingerprint images, and the working hours that are received in operation 201. In this instance, the ID and the plurality of fingerprint images may be stored with the ID mapped to the plurality of fingerprint images.

Here, the ID may include at least one temporary ID assigned to the user for a short period of time, and the at least one ID may include a resident registration number of the user, a telephone number of the user, and a representation of combinations of numbers, characters, and special characters.

Since the temporary ID may be used, the user may easily record the working hours even though the user forgets the ID or is not yet assigned the ID.

When the temporary ID is used, the method of managing working hours using post-factum fingerprint registration may further include an operation of mapping the at least one temporary ID to the ID corresponding to the plurality of fingerprint images before or after storing the ID and the plurality of fingerprint images in operation 203.

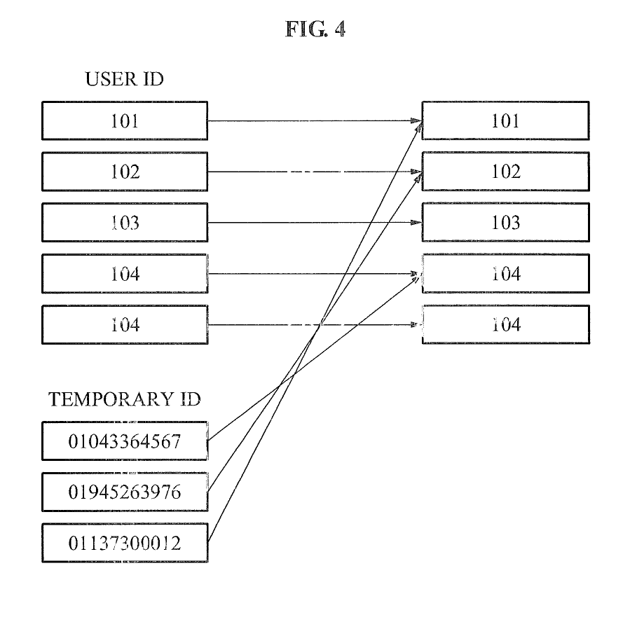

The mapping of the temporary ID to the (user) ID is described with regard to FIG. 4.

FIG. 4 is a diagram illustrating ID mapping in the method and system for managing working hours using post-factum fingerprint registration according to an exemplary embodiment of the present invention.

Referring to FIG. 4, when an employee uses a plurality of IDs including a user ID and a temporary ID, the method of managing working hours using post-factum fingerprint registration may classify working hours using a single ID, for example, a (user) ID, through ID mapping. When a plurality of IDs are not used, ID mapping may be omitted.

For example, when the employee fails to recall an ID, ‘101’, assigned to the employee, the employee may input ‘01137300012’ in a telephone number, 011-3730-0012, as a temporary ID, along with a fingerprint. The system for managing working hours using post-factum fingerprint registration may map the temporary ID, ‘01137300012’ to the ID ‘101’ corresponding to a plurality of fingerprint images before or after performing the operation 203.

In this instance, the temporary ID, the (user) ID, and the plurality of fingerprint images corresponding to the ID may be all stored, and the temporary ID may be changed to the (user) ID mapped to the temporary ID, and the (user) ID and the plurality of fingerprint images corresponding to the ID may be only stored.

A method of storing the plurality of fingerprint images in operation 203 may include various methods as follows.

The plurality of fingerprint images may be stored without processing. In this case, fingerprint image data may have a large size but a high storage rate, and various algorithms may be applied to the stored fingerprint images.

The plurality of fingerprint images may be compressed using various image compression algorithms. A fingerprint recognition algorithm may be applied to the plurality of compressed fingerprint images, and may reduce a data size. However, when a complex compression algorithm is used, a storage rate may increase.

In this instance, the fingerprint recognition algorithm may include, for example, a wavelet scalar quantization (WSQ) algorithm, and losslessly compressed fingerprint images may be obtained using the algorithm.

Also, a method using loss image compression and feature data may be used.

This method may include extracting feature data from the plurality of fingerprint images, performing lossy compression on the plurality of fingerprint images, and storing the plurality of lossy compressed fingerprint images. Since a fingerprint recognition algorithm fails to be applied to lossy compressed fingerprint images, an operator needs to visually compare the fingerprints in person.

This method may allow a small data size and a high image compression rate of the fingerprint images.

Also, a method using feature data and partial fingerprint images may be used. This method may store partial images of the plurality of fingerprint images.

Generally, in a case in which personal biometric information is stored, an issue may be raised with regard to infringement on human rights. In particular, in a recent situation in which biometric information is used for personal identification, a fingerprint may correspond to information having an important meaning. Accordingly, storing of partial fingerprint image but not the entire fingerprint image may prevent biometric information having an important meaning from being stored.

To store partial images of the fingerprint images, for example, a method of storing a part of a circumferential image around a center point of a fingerprint may be used. This method may include comparing the fingerprints using feature data, and when a match rate is low, enabling the operator to visually compare the fingerprints using parts of the stored fingerprint images.

In operation 205, the system for managing working hours using post-factum fingerprint registration may select a post-factum registration fingerprint image for the ID from the plurality of fingerprint images stored in operation 203, and may perform post-factum fingerprint registration.

In this instance, the post-factum registration fingerprint image may be selected at random.

Also, when the selected post-factum registration fingerprint image is absent, a first stored fingerprint image or a last stored fingerprint image among the plurality of fingerprint images stored in operation 203 may be selected as the post-factum registration fingerprint image.

When the first stored fingerprint image or the last stored fingerprint image, as a default value, is set as the post-factum registration fingerprint image, the operation of selecting the post-factum registration fingerprint image may be omitted, and operation 207 of comparing the fingerprint images may be directly performed.

In operation 207, the post-factum registration fingerprint image may be compared to the remaining fingerprint images among the plurality of fingerprint images.

That is, operation 207 may be performed to verify whether the fingerprint images used in recording the working hours are fingerprints inputted by a legitimate user.

Accordingly, a match rate of the post-factum registration fingerprint image and the plurality of fingerprint images may be compared, and when the match rate is lower than a predetermined match rate, a warning may be recorded or displayed with respect to the ID corresponding to the plurality of fingerprint images.

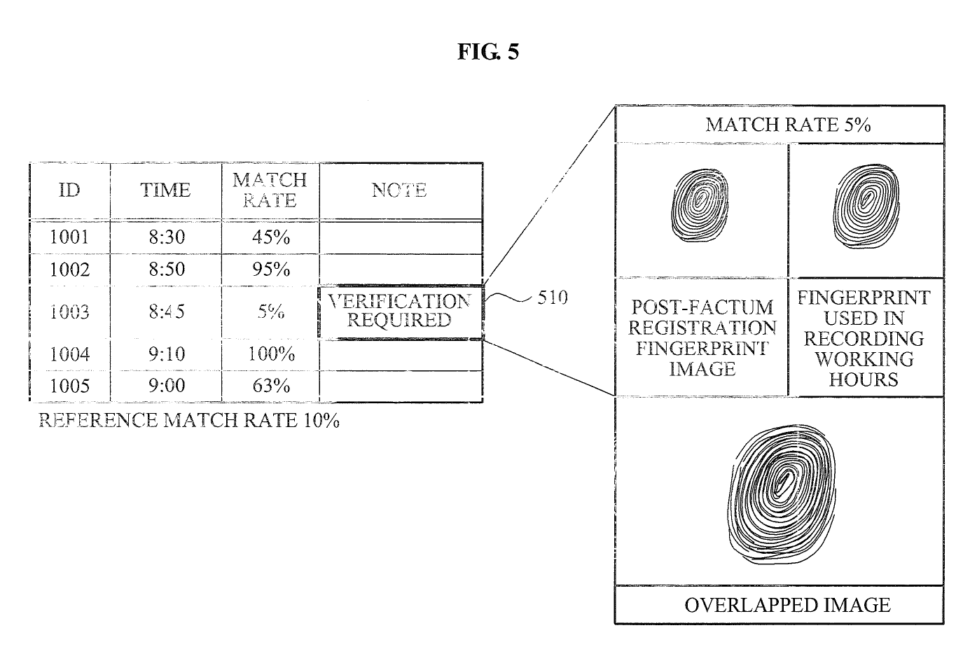

The fingerprint match rate and the fingerprint image verification is described with regard to FIG. 5.

FIG. 5 is a diagram illustrating the fingerprint match rate and the fingerprint image in the method and system for managing working hours using post-factum fingerprint registration according to an exemplary embodiment of the present invention.

Referring to FIG. 5, the method and system for managing working hours using post-factum fingerprint registration may compare the registered post-factum registration fingerprint image to the fingerprint images used in recording the working hours, and may display a match rate. In this instance, a reference match rate may be preset, and a warning may be recorded or displayed with respect to a working hours record having a match rate lower than the reference match rate.

Accordingly, an immoral record made on behalf of another employee, so-called buddy punching, may be verified by displaying a fingerprint match rate on a working hours record and examining a warning for a fingerprint image of a suspicious record.

In this instance, the system for managing working hours using post-factum fingerprint registration may enable the operator to verify whether the fingerprint images used in recording the working hours is identical to the registered post-factum registration fingerprint image by overlapping the registered post-factum registration fingerprint image and the fingerprint images used in recording the working hours, for the operator to easily distinguish the fingerprint images. Through this, the system for managing working hours using post-factum fingerprint registration or the operator may compare and analyze the overlapped image thoroughly using a function of horizontal movement, rotation, and the like.

Also, the system for managing working hours using post-factum fingerprint registration or the operator may selectively verify a fingerprint image of a working hours record having a low match rate, to prevent buddy punching.

Also, referring to FIG. 5, it is found that a fingerprint match rate corresponding to an ID of a predetermined employee is remarkably low.

In this instance, a match rate may be lower than a predetermined match rate in a case in which deformation occurs to a fingerprint image depending on an angle of finger placement, a pressing pressure of a finger, and the like, and the deformed fingerprint image is stored in a fingerprint registering terminal. However, since there is a limit on the degree of deformation, a case in which a match rate is lower than a reference match rate, for example, 10%, may be exceptional.

That is, for example, when a match rate of the registered post-factum registration fingerprint image of the user and the plurality of fingerprint images stored as a daily working hours record is determined to be 5% as shown in 510 of FIG. 5, the match rate may correspond to a fingerprint image match rate that is difficult to determined, to be inputted by an employee having a corresponding ID.

Accordingly, in this case, since it is a high possibility that the fingerprint image inputted for the corresponding ID corresponds to a fingerprint of another employee, a warning may be recorded to indicate that verification is needed for the corresponding ID.

Also, according to embodiments, in operation 207 of comparing the fingerprint images, a case in which a match rate is lower than the predetermined match rate may be counted, and when the counted number of times corresponds to a predetermined number of times, the method may revert to operation 205 to select, as a post-factum registration fingerprint image, one of the plurality of fingerprint images aside from the post-factum registration fingerprint image.

For example, when an incorrectly recognized fingerprint or a fingerprint inputted immorally by another employee is registered as a post-factum registration fingerprint image, even though a fingerprint of a legitimate user is inputted, a match rate may be continuously lower than the predetermined match rate.

Accordingly, a number of times at which a match rate is low may be counted, and it may be determined whether the number of times at which the match rate is lower than the predetermine match rate corresponds to the predetermined number of times, for example, three times. Also, when the number of times at which the match rate is lower than the predetermine match rate corresponds to the predetermined number of times, one of the plurality of fingerprint images aside from the post-factum registration fingerprint image may be selected as the post-factum registration fingerprint image.

That is, replacement of the immorally registered post-factum registration fingerprint image may be executed.

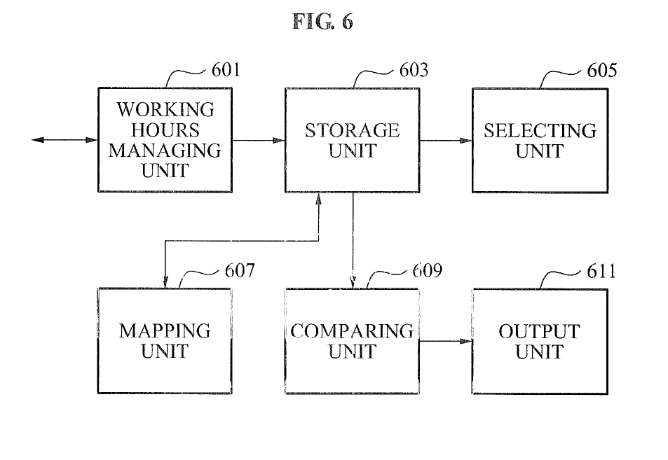

FIG. 6 is a block diagram illustrating a system for managing working hours using post-factum fingerprint registration according to an exemplary embodiment of the present invention.

Referring to FIG. 6, the system for managing working hours using post-factum fingerprint registration according to an exemplary embodiment of the present invention may include a working hours managing unit 601, a storage unit 603, a selecting unit 605, and a comparing unit 609.

Also, the system for managing working hours using post-factum fingerprint registration according to an exemplary embodiment of the present invention may further include a mapping unit 607 and an output unit 611.

The working hours managing unit 601 may determine working hours of a user in response to provision of an ID inputted from the user and each of a plurality of fingerprint images corresponding to the ID. In this instance, the working hours managing unit 601 may determine the working hours of the user irrespective of whether the plurality of fingerprint images are fingerprint images of the user.

The storage unit 603 may store the ID, the plurality of fingerprint images, and the working hours, and in this instance, the ID and the plurality of fingerprint images may be stored with the ID mapped to the plurality of fingerprint images.

The selecting unit 605 may select a post-factum registration fingerprint image for the ID from the plurality of fingerprint images.

Also, the selecting unit 605 may select the post-factum registration fingerprint image at random. Also, when the post-factum registration fingerprint image is absent, the selecting unit 605 may select, as the post-factum registration fingerprint image, a first stored fingerprint image or a last stored fingerprint image among the plurality of fingerprint images.

The mapping unit 607 may map at least one temporary ID to the ID corresponding to the plurality of fingerprint images.

The comparing unit 609 may compare the post-factum registration fingerprint image selected by the selecting unit 605 to the remaining fingerprint images among the plurality of fingerprint images.

The output unit 611 may output a result of the comparison by the comparing unit 609. Also, the output unit 611 may generate an alarm for at least one of the plurality of fingerprint images based on the result of the comparison by the comparing unit 609.

The system for managing working hours using post-factum fingerprint registration according to an exemplary embodiment of the present invention described through FIG. 6 may correspond to an apparatus for performing the method of managing working hours using post-factum fingerprint registration according to an exemplary embodiment of the present invention described through FIGS. 1 through 5.

Accordingly, although hereinafter omitted, the disclosure of the method of managing working hours using post-factum fingerprint registration described through FIGS. 1 through 5 may be applied to the system for managing working hours using post-factum fingerprint registration according to an exemplary embodiment of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for managing working hours using post-factum fingerprint registration, the method comprising:
determining working hours of a user in response to provision of an identification (ID) inputted from the user and each of a plurality of fingerprint images corresponding to the ID;
storing the ID, the plurality of fingerprint images, and the working hours;
selecting a post-factum registration fingerprint image for the ID from the plurality of fingerprint images; and
comparing the post-factum registration fingerprint image to remaining fingerprint images among the plurality of fingerprint images.

2. The method of claim 1, wherein the determining working hours of the user comprises determining working hours of the user irrespective of whether the plurality of fingerprint images are fingerprint images of the user.

3. The method of claim 1, wherein the storing of the ID, the plurality of fingerprint images, and the working hours comprises storing the ID, the plurality of fingerprint images, and the working hours with the ID mapped to the plurality of fingerprint images.

4. The method of claim 1, further comprising at least one temporary ID assigned to the user for a short period of time, and
the method further comprises mapping the at least one temporary ID to the ID corresponding to the plurality of fingerprint images.

5. The method of claim 1, wherein the storing of the ID, the plurality of fingerprint images, and the working hours comprises:
extracting feature data from the plurality of fingerprint images; and
performing lossy compression on the plurality of fingerprint images and storing the plurality of lossy compressed fingerprint images.

6. The method of claim 1, wherein the selecting of the post-factum registration fingerprint image comprises selecting, as the post-factum registration fingerprint image, a first stored fingerprint image or a last stored fingerprint image among the plurality of fingerprint images, when the post-factum registration fingerprint image is absent.

7. The method of claim 1, wherein the comparing of the post-factum registration fingerprint image to the remaining fingerprint images among the plurality of fingerprint images comprises:
comparing a match rate of the post-factum registration fingerprint image and the plurality of fingerprint images; and
recording a warning with respect to the ID corresponding to the plurality of fingerprint images when the match rate is lower than a predetermined match rate.

8. The method of claim 7, wherein the selecting of the post-factum registration fingerprint image comprises:
determining whether a number of times at which the match rate is lower than the predetermined match rate corresponds to a predetermined number of times; and
selecting, as the post-factum registration fingerprint image, one of the plurality of fingerprint images aside from the post-factum registration fingerprint image, when it is determined that the number of times at which the match rate is lower than the predetermined match rate corresponds to the predetermined number of times.

9. A system for managing working hours using post-factum fingerprint registration, the system comprising:
a working hours managing unit to determine working hours of a user in response to provision of an identification (ID) inputted from the user and each of a plurality of fingerprint images corresponding to the ID;
a storage unit to store the ID, the plurality of fingerprint images, and the working hours;
a selecting unit to select a post-factum registration fingerprint image for the ID from the plurality of fingerprint images; and
a comparing unit to compare the post-factum registration fingerprint image to the remaining fingerprint images among the plurality of fingerprint images.

10. The system of claim 9, further comprising:
an output unit to output a result of the comparison.

11. The system of claim 10, wherein the output unit generates an alarm for at least one of the plurality of fingerprint images based on the result of the comparison.

12. The system of claim 9, wherein the working hours managing unit determines the working hours of the user irrespective of whether the plurality of fingerprint images are fingerprint images of the user.

13. The system of claim 9, wherein the storage unit stores the ID, the plurality of fingerprint images, and the working hours with the ID mapped to the plurality of fingerprint images.

14. The system of claim 9, wherein the storage unit extracts feature data from the plurality of fingerprint images and stores partial images of the plurality of fingerprint images.

15. The system of claim 9, wherein the ID includes at least one temporary ID assigned to the user for a short period of time.

16. The system of claim 15, further comprising:
a mapping unit to map the at least one temporary ID to the ID corresponding to the plurality of fingerprint images.

17. The system of claim 9, wherein the storage unit compresses the plurality of fingerprint images by a lossless image compression algorithm, and stores the plurality of compressed fingerprint images.

18. The system of claim 9, wherein the storage unit extracts feature data from the plurality of fingerprint images, performs lossy compression on the plurality of fingerprint images, and stores the plurality of compressed fingerprint images.

19. The system of claim 9, wherein the selecting unit selects the post-factum registration fingerprint image at random.

20. The system of claim 9, wherein the selecting unit selects, as the post-factum registration fingerprint image, a first stored fingerprint image or a last stored fingerprint image among the plurality of fingerprint images, when the post-factum registration fingerprint image is absent.

21. The system of claim 9, wherein the comparing unit records a warning with respect to the ID corresponding to the plurality of fingerprint images when a match rate of the post-factum registration fingerprint image and the plurality of fingerprint images is lower than a predetermined match rate based on the result of the comparison.

22. The system of claim 21, wherein the selecting unit selects, as the post-factum registration fingerprint image, one of the plurality of fingerprint images aside from the post-factum registration fingerprint image, when it is determined that a number of times at which the match rate is lower than the predetermined match rate corresponds to a predetermined number of times.
